(19) United States
(12) Patent Application Publication
(10) Pub. No.: US 2004/0107038 A1
(43) Pub. Date: Jun. 3, 2004

(54) Torque controller of internal combustion engine

(75) Inventor: Naoki Osumi, Kariya-city (JP)

Correspondence Address: NIXON & VANDERHYE, PC, 1100 N GLEBE ROAD, 8TH FLOOR, ARLINGTON, VA, 22201-4714, US

(73) Assignee: DENSO CORPORATION, Kariya-city (JP)

(21) Appl. No.: 10/721,077

(22) Filed: Nov. 26, 2003

(30) Foreign Application Priority Data
Nov. 29, 2002 (JP) 2002-347621

(51) Int. Cl. G06G 7/70

(52) U.S. Cl. 701/102

(57) ABSTRACT

A torque controller of an internal combustion engine provides smooth variations of target engine shaft torque in response to parameter inputs. The torque controller performs: a target engine output power operating process in which target engine output power is determined from a one-dimensional table based on the accelerator opening; a target engine output torque operating process in which target engine output torque is calculated in response to this target engine output power, by using a predetermined formula based on the number of engine revolutions; and a target engine shaft torque operating process in which an engine torque loss is subtracted from the target engine output torque to calculate the target engine shaft torque. This permits smooth variations of the target engine output torque and target engine shaft torque calculated by the formulae for improved torque control.

### CROSS REFERENCE TO RELATED APPLICATION

This application is based upon, claims the benefit of priority of, and incorporates by reference Japanese Patent Application No. 2002-347621 filed Nov. 29, 2002.

### BACKGROUND OF THE INVENTION

1. Field of the Invention

The present invention relates to a torque controller of an internal combustion engine for controlling the output torque of the internal combustion engine according to driver requests.

2. Description of the Related Art

Generally a known document pertaining to a torque controller of an internal combustion engine is Japanese Patent Laid-Open Publication No. Hei 11-324733. This publication discloses a technology concerning an electronically controlled internal combustion engine of a fuel injection type having an electronic accelerator system. In the technology, the target torque value of the drive shaft of the internal combustion engine, or target engine shaft torque (necessary torque), is adjusted in accordance with the amount of operation of the accelerator pedal and the number of engine revolutions at that point in time even if mechanisms that can cause torque variations, such as a variable intake control mechanism and a variable valve timing control mechanism, are incorporated in the engine (see Japanese Patent Laid-Open Publication No. Hei 11-324733, p. 2).

In the foregoing, the target engine shaft torque is calculated from the detected value of accelerator opening, which corresponds to the amount of operation of the accelerator pedal, and the number of engine revolutions at that point. Specifically, for conventional control, a two-dimensional map with two inputs and one output as shown in FIG. 5 is used to determine a target engine shaft torque [N·m: newton meters] from a plurality of parameter inputs, the accelerator opening Aacc [°] and the number of engine revolutions Ne [rpm].

To establish this two-dimensional map, target engine shaft torques must be obtained under the application of a plurality of combinations of the parameters, or the accelerator opening and the number of engine revolutions, with enormous man-hours of application. In addition, since the two-dimensional map established inevitably takes the form of a line graph covering the plurality of combinations, there has been the problem that the target engine shaft torque cannot be changed smoothly in response to parameter inputs.

### SUMMARY OF THE INVENTION

The present invention has been achieved to solve the foregoing problems. It is thus an object of the present invention to provide a torque controller of an internal combustion engine which can reduce the man-hours of application and provide smooth changes in variations of the target engine shaft torque in response to parameter inputs.

In a torque controller of an internal combustion engine according to a first aspect of the present invention, a target engine output power operating means determines the target engine output power by using such means as a one-dimensional table or a formula on only a single factor of application, that is, the amount of accelerator operation by a driver. In response to this target engine output power, the target engine output torque operating means calculates a target engine output torque, for the internal combustion engine to produce through combustion, as a physical quantity pertaining to the target engine shaft torque by using a predetermined formula based on, as parameters, the target engine output power and the number of engine revolutions detected by rotational speed detecting means. Based on this target engine output torque, a control means drives an actuator installed on the internal combustion engine. This can reduce the man-hours of application, and achieve smooth transitions between variations of the target engine output torque, or the physical quantity pertaining to the target engine shaft torque, calculated by the formula based on the target engine output power and the number of engine revolutions as parameters for improved torque controllability. As a result, the actuator installed on the internal combustion engine is favorably driven.

In the torque controller of an internal combustion engine according to a second aspect of the invention, an engine torque loss operating means calculates an engine torque loss, which is a mechanical energy loss of the internal combustion engine. Target engine shaft torque operating means subtracts the engine torque loss from the target engine output torque which is an intermediate physical quantity pertaining to the target engine shaft torque, whereby the target engine shaft torque is finally calculated. Consequently, since it is calculated by simply subtracting the engine torque loss from the target engine output torque which is smoothly changed, the target engine shaft torque is also smoothly changed as the target engine output torque is. The actuator is thus favorably driven.

In the torque controller of an internal combustion engine according to a third aspect, the predetermined formula is given by:

T=P/Ne,

where T is the target engine output torque, P is the target engine output power, and Ne is the number of engine revolutions. Since the target engine output torque is calculated by the simple formula of dividing the target engine output power by the number of engine revolutions, it is possible to reduce the man-hours of application and achieve smooth variations of the target engine output torque for improved torque controllability. As a result, the actuator installed on the internal combustion engine is favorably driven.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram showing the general configuration of a torque controller of an internal combustion engine according to the embodiment of the present invention;

FIG. 2 is a flowchart showing the procedure for determining the target engine shaft torque in a control unit used in the torque controller of an internal combustion engine according to the embodiment of the present invention;

FIG. 3 is a table for determining target engine output power in FIG. 2 using the accelerator opening as a parameter;

FIG. 4 is a graph showing the relationship between the number of engine revolutions and the target engine output torque for respective target engine output powers in FIG. 3; and

FIG. 5 is a two-dimensional map used in conventional control, in which the target engine shaft torque is determined using the accelerator opening and the number of engine revolutions as parameters.

### DETAILED DESCRIPTION OF THE PREFERRED EMBODIMENT

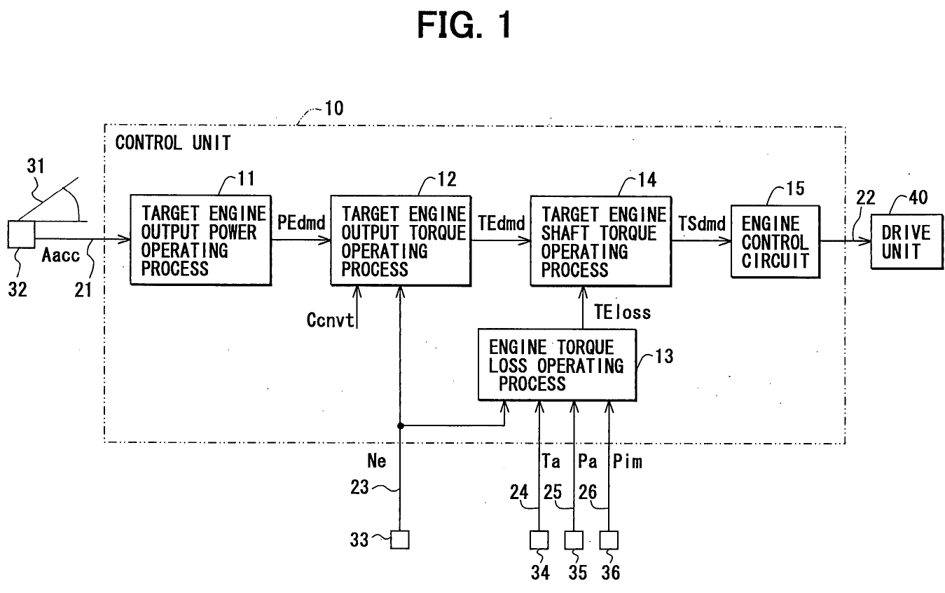

The following description of the preferred embodiment is merely exemplary in nature and is in no way intended to limit the invention, its application, or uses. FIG. 1 is a block diagram showing the general configuration of a torque controller of an internal combustion engine according to the embodiment of the present invention.

In FIG. 1, the reference numeral 10 represents a vehicle control unit, which is connected with a drive unit 40 of an internal combustion engine through an output line 22. The control unit 10 is also connected with an accelerator-opening sensor 32 through an input line 21. The accelerator-opening sensor 32 inputs accelerator opening Aacc [°], corresponding to the amount of operation of an accelerator pedal 31 which is operable by the driver, to the control unit 10. The control unit 10 is also connected with a rotational speed sensor 33, an intake temperature sensor 34, an ambient pressure sensor 35, and an intake pressure sensor 36 through input lines 23, 24, 25, and 26, respectively. The control unit 10 receives such inputs as the number of engine revolutions Ne [rpm], intake temperature Ta [° C.], ambient pressure Pa [kPa: kilopascals], and intake pressure Pim [kPa] from the sensors 33 to 36, respectively.

The control unit 10 is configured as a logic operation circuit including a CPU, a ROM, a RAM, a B/U (back-up) RAM, input circuits, an output circuit, and a bus line. The CPU functions as a central processing unit for performing various types of known processing. The ROM contains a control program, a control map, etc. The RAM stores various data. The input circuits input various sensor signals including those from the input lines 21, 23, 24, 25, and 26 mentioned above. The output circuit outputs control signals and the like to the output line 22 mentioned above. The bus line connects these components.

Now, detailed description will be provided for the individual blocks in FIG. 1 which show respective steps of the control program of the control unit 10 for use in the torque controller of an internal combustion engine according to the embodiment of the present invention. Of the individual blocks shown in FIG. 1, a target engine output power operating process 11 accepts the accelerator opening Aacc from the accelerator-opening sensor 32. Based on this accelerator opening Aacc, the target engine output power operating process 11 calculates target engine output power PEdmd.

A target engine output torque operating process 12 accepts the target engine output power PEdmd calculated by the target engine output power operating process 11, the number of engine revolutions Ne from the rotational speed sensor 33, and a constant (constant value) Ccnvt. Based on these input values, the target engine output torque operating process 12 calculates target engine output torque TEdmd [N·m]. This target engine output torque TEdmd [N·m] is the output torque for the internal combustion engine to produce through combustion according to the driver request.

An engine torque loss operating process 13 accepts the number of engine revolutions Ne from the rotational speed sensor 33, the intake temperature Ta from the intake temperature sensor 34, the ambient pressure Pa from the ambient pressure sensor 35, and the intake pressure Pim from the intake pressure sensor 36. Based on these input values, the engine torque loss operating process 13 calculates an engine torque loss TEloss [N·m]. This engine torque loss TEloss [N·m] is what the output torque produced by the combustion of the internal combustion engine loses due to pumping loss, friction, and so on. The engine torque loss TEloss [N·m] calculated by this engine torque loss operating process 13 and the target engine output torque TEdmd [N·m] calculated by the target engine output torque operating process 12 are input to a target engine shaft torque operating process 14.

The target engine shaft torque operating process 14 calculates the target engine shaft torque TSdmd [N·m] for the drive shaft of the internal combustion engine to produce, while taking account of the engine torque loss TEloss [N·m], and other driving parameters if necessary, with respect to the target engine output torque TEdmd [N·m] input thereto. The target engine shaft torque TSdmd [N·m] calculated by this target engine shaft torque operating process 14 is input to an engine control circuit 15. The engine control circuit 15 adjusts the drive unit 40 in accordance with the target setting, or the target engine shaft torque TSdmd [N·m] input thereto.

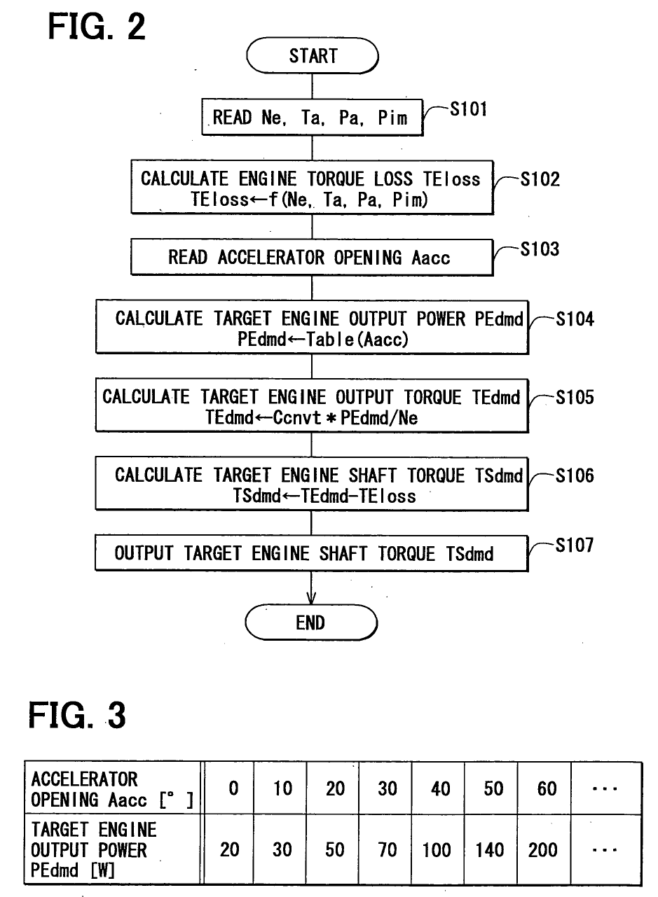

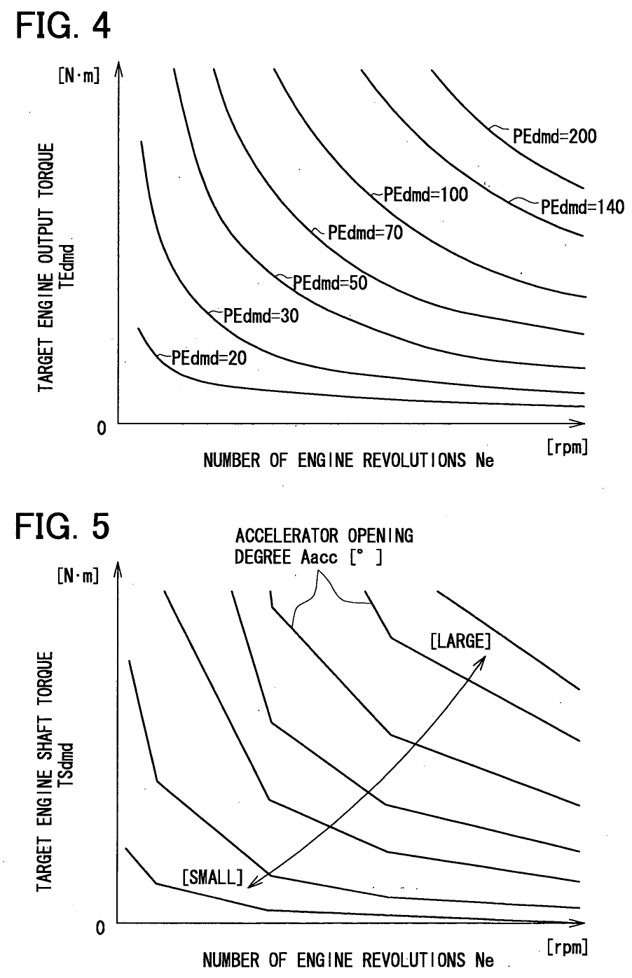

Next, description of the flowchart of FIG. 2 with reference to FIGS. 1, 3, and 4 will be provided. FIG. 2 shows the procedure for determining the target engine shaft torque based on the target engine output power, the target engine output torque, and the engine torque loss in the control unit 10 for use in the torque controller of an internal combustion engine according to the embodiment of the present invention. FIG. 3 is a table for determining the target engine output power PEdmd [W: watts] in FIG. 2 with the accelerator opening Aacc [°] as the parameter. FIG. 4 is a graph showing the relationship between the number of engine revolutions Ne and the target engine output torque TEdmd for respective target engine output powers PEdmd in FIG. 3. Incidentally, this target engine shaft torque calculating routine is repeated by the control unit 10 at predetermined time intervals.

In FIG. 2, at step S101, the number of engine revolutions Ne [rpm], the intake temperature Ta [° C.], the ambient pressure Pa [kPa], and the intake pressure Pim [kPa] are initially read from the rotational speed sensor 33, the intake temperature sensor 34, the ambient pressure sensor 35, and the intake pressure sensor 36, respectively. Next, at step S102, the engine torque loss TEloss [N·m], or the mechanical energy loss of the internal combustion engine, is calculated from the number of engine revolutions Ne, the intake temperature Ta, the ambient pressure Pa, and the intake pressure Pim which are read at step S101. Incidentally, this step S102 corresponds to the engine torque loss operating process 13 in FIG. 1.

Next, at step S103, the accelerator opening Aacc [°], corresponding to the amount of operation of the accelerator pedal 31 by the driver, is read from the accelerator-opening sensor 32. Next, at step S104, the target engine output power PEdmd [W] is determined from a pre-stored one-dimensional table, Table (Aacc), shown in FIG. 3 with the accelerator opening Aacc [°] read at step S103 as the parameter. For intermediate values of the accelerator opening Aacc [°], the target engine output power PEdmd is calculated by known interpolation processing. Incidentally, step S104 corresponds to the target engine output power operating process 11 in FIG. 1.

Next, at step S105, the target engine output power PEdmd [W] calculated at step S104 is divided by the number of engine revolutions Ne [rpm] read at step S101. The resultant is multiplied by the constant Ccnvt for torque conversion, whereby the target engine output torque TEdmd [N·m] is calculated which is shown on the chart. The foregoing operation is given by the following equation (1). Incidentally, this step S105 corresponds to the target engine output torque operating process 12 in FIG. 1.

TEdmd=Ccnvt×PEdmd/Ne. (1)

FIG. 4 is a graph showing the target engine output torque TEdmd at a number of engine revolutions Ne by acceleration opening Aacc, obtained from the equation (1). At a given target engine output power PEdmd, the number of engine revolutions Ne and the target engine output torque TEdmd are generally in inverse proportion to each other.

Next, at step S106, the engine torque loss TEloss [N·m] calculated at step S102 is subtracted from the target engine output torque TEdmd [N·m] calculated at step S105 to obtain the target engine shaft torque TSdmd [N·m] as shown by the following equation (2). Incidentally, this step S106 corresponds to the target engine shaft torque operating process 14 in FIG. 1.

TSdmd=TEdmd−TEloss. (2)

Next, at step S107, the target engine shaft torque TSdmd [N·m] calculated at step S106 is output to the engine control circuit 15 to complete this routine.

As above, the torque controller of an internal combustion engine according to this embodiment has a target engine output power operating means achieved by the target engine output power operating process 11 of the control unit 10. The target engine output power Pedmd, for the internal combustion engine (not shown) to produce through combustion, is calculated based on the accelerator opening Aacc from the accelerator-opening sensor 32, which corresponds to the amount of operation of the accelerator pedal 31 of the driver. The rotational speed sensor 33 as a rotational speed detecting means detects the number of engine revolutions Ne of the internal combustion engine. There is a target engine output torque operating means achieved by the target engine output torque operating process 12 of the control unit 10, in which the target engine output torque Tedmd, for the internal combustion engine to produce through combustion, is calculated based on the target engine output power PEdmd calculated by the target engine output power operating process 11 and the number of engine revolutions Ne detected by the rotational speed sensor 33. Finally, there is a control means of the control unit 10 which drives the drive unit 40, i.e., the actuator installed on the internal combustion engine based on the target engine output torque TEdmd calculated by the target engine output torque calculating process 12. In the target engine output torque calculating process 12, the target engine output torque TEdmd is calculated with the predetermined formula given by the foregoing equation (1).

More specifically, the target engine output power PEdmd is obtained from the one-dimensional table based on the accelerator opening Aacc. In response to the target engine output power PEdmd, the target engine output torque TEdmd, or an intermediate physical quantity pertaining to the target engine shaft torque TSdmd, is calculated by the foregoing equation (1) based on the number of engine revolutions Ne. The drive unit 40 installed on the internal combustion engine is driven based on this target engine output torque TEdmd. This can reduce the man-hours for application, and achieve smooth variations of the target engine output torque TEdmd which is a physical quantity pertaining to the target engine shaft torque TSdmd calculated by the equation based on the number of engine revolutions Ne. The drive unit 40 can thus be favorably driven.

Moreover, the torque controller of an internal combustion engine according to this embodiment also has an engine torque loss operating means achieved by the engine torque loss operating process 13 of the control unit 10, in which the mechanical energy loss of the internal combustion engine is calculated as the engine torque loss Teloss. The torque controller also has a target engine shaft torque operating means achieved by the target engine shaft torque operating process 14 of the control unit 10, in which the target engine shaft torque TSdmd is calculated based on the target engine output torque TEdmd calculated by the target engine output torque operating process 12 and the engine torque loss TEloss calculated by the engine torque loss operating process 13. The control means achieved by the control unit 10 drives the drive unit 40, an actuator, based on the target engine shaft torque TSdmd calculated by the target engine shaft torque operating process 14.

That is, the target engine shaft torque TSdmd is finally calculated by subtracting the engine torque loss TEloss from the target engine output torque TEdmd which is a physical quantity pertaining to the target engine shaft torque TSdmd. Consequently, since it is calculated by simply subtracting the engine torque loss TEloss from the target engine output torque TEdmd which is smoothly changed, the target engine shaft torque TSdmd can also be smoothly changed as the target engine output torque TEdmd is. The drive unit 40 can thus be favorably driven.

In the foregoing embodiment, the target engine output power PEdmd for an accelerator opening Aacc is obtained by using the one-dimensional table. Nevertheless, the present invention is not limited to such mode of application, but may incorporate calculation using a predetermined formula. When the target engine output power PEdmd for an acceleration opening Aacc can be calculated by using a formula, the effect of an additional reduction in the man-hours of application can be expected.

Finally, a torque controller for an internal combustion engine has a target engine output power operating means for calculating a target engine output power, which an internal combustion engine produces through combustion, in accordance with an amount of operation of an accelerator by a driver; a rotational speed detecting means for detecting a number of engine revolutions of said internal combustion engine; a target engine output torque operating means for calculating target engine output torque, which the internal combustion engine produces through combustion, based on the target engine output power calculated by said target engine output power operating means and the number of engine revolutions detected by said rotational speed detecting means; and a control means for driving an actuator installed on said internal combustion engine based on the target engine output torque calculated by said target engine output torque operating means, such that said target engine output torque operating means calculates the target engine output torque by using a predetermined formula with the target engine output power and the number of engine revolutions as parameters.

The torque controller of an internal combustion engine may further have an engine torque loss operating means for calculating a mechanical energy loss of said internal combustion engine as engine torque loss; and a target engine shaft torque operating means for calculating the target engine shaft torque based on the target engine output torque calculated by said target engine output torque operating means and the engine torque loss calculated by said engine torque loss operating means, such that said control means drives said actuator based on the target engine shaft torque calculated by said target engine shaft torque operating means.

The torque controller of an internal combustion engine may also utilize a predetermined formula such as T=P/Ne, where T is the target engine output torque, P is the target engine output power, and Ne is the number of engine revolutions.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A torque controller for an internal combustion engine, comprising:
means for calculating target engine output power, which an internal combustion engine produces through combustion, in accordance with an amount of accelerator operation by a driver;
means for detecting a number of engine revolutions of said internal combustion engine;
means for calculating target engine output torque, which said internal combustion engine produces through combustion, based on the target engine output power calculated by said target engine output power calculating means and the number of engine revolutions detected by said rotational speed detecting means; and
means for driving an actuator installed on said internal combustion engine based on the target engine output torque calculated by said target engine output torque calculating means, wherein
said target engine output torque calculating means calculates the target engine output torque using a predetermined formula with the target engine output power and the number of engine revolutions as parameters.

2. The torque controller for an internal combustion engine according to claim 1, further comprising:
means for calculating a mechanical energy loss of said internal combustion engine as engine torque loss; and
means for calculating the target engine shaft torque based on the target engine output torque calculated by said target engine output torque calculating means and the engine torque loss calculated by said engine torque loss operating means, and wherein
said control means drive said actuator based on the target engine shaft torque calculated by said target engine shaft torque calculating means.

3. The torque controller for an internal combustion engine according to claim 1, wherein said predetermined formula is given by:
T=P/Ne, where T is the target engine output torque, P is the target engine output power, and Ne is the number of engine revolutions.

4. The torque controller for an internal combustion engine according to claim 2, wherein said predetermined formula is given by:
T=P/Ne, where T is the target engine output torque, P is the target engine output power, and Ne is the number of engine revolutions.
